(19) United States
(12) Patent Application Publication
(10) Pub. No.: US 2007/0143352 A1
(43) Pub. Date: Jun. 21, 2007

(54) Method and system for implementing database migration using a staged approach

(75) Inventors: Robert T. Dunn, Elizaville, NY (US); Takao Inouye, Danbury, CT (US); Daniel H. Jacobs, Poughkeepsie, NY (US); Kevin T. Jones, Poughkeepsie, NY (US); Waseem A. Majeed, Bedford, TX (US); Peter G. Sutton, LaGrangeville, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/315,440

(22) Filed: Dec. 21, 2005

(51) Int. Cl. G06F 17/30

(52) U.S. Cl. 707/200

(57) ABSTRACT

A method for implementing staged database migration of a database includes implementing a first migration stage by expanding headers for one or more subfiles from a first file address format to a second file address format, wherein subsequent overflow blocks to be associated with said one or more subfiles are selectable from an address space corresponding to said second file address format. A second migration stage is implemented, including expanding file address references of one or more index files from the first file address format to the second address format. The file address references are located within logical records (LRECs) in the one or more index files, the file address references pointing to one or more of the subfiles.

### BACKGROUND

The present invention relates generally to database management and, more particularly, to a method and system for implementing database migration using a staged approach.

The TPF Database Facility (TPFDF) is an IBM program product configured to run on Transaction Processing Facility (TPF) operating systems, providing users with high transaction rates in accessing database records. TPF delivers fast, high-volume, high-throughput transaction processing, handling large, continuous loads of essentially simple transactions across large, geographically dispersed networks. The current TPF operating system traces its origins to the airline industry and is also presently used, for example, by hotel chains, credit card companies, banking and other financial institutions.

A TPFDF database is made up of files, each of which contains one or more subfiles. FIG. 1 illustrates the logical structure of an exemplary TPFDF file 100 having a pair of subfiles 102. Each of the subfiles 102, in turn, includes a prime block 104 and a plurality of overflow blocks 106 associated therewith. However, in actuality, subfiles may have any number of overflow blocks, or none at all. In any case, the prime block 104 and any overflow blocks 106 contain logical records (LRECs) 108 that contain the actual user/customer data stored in physical file records on disk. Other portions of the block (e.g., the header) also contain data used by the TPFDF. One example of a TPFDF file may be a list of employees of an organization, wherein the subfiles represent the LRECs for subsets of the employees broken down by surname letter (i.e., A, B, C, . . . , Z).

Whenever the volume of data in a subfile 102 exceeds the capacity of the prime block 104, the TPFDF product automatically allocates one or more overflow blocks 106 to hold the extra data. In addition, the TPFDF chains any overflow blocks to the prime block that requires them (as shown in FIG. 2). As further illustrated in FIG. 1, each block contains a header 110 and an optional trailer 112. The optional trailer 112 contains, for example, certain control information such as the last command issued, as well as the date and time the block was last updated. All physical blocks in a file, regardless of whether they are prime or overflow blocks, have the same file ID 114. The file ID 114 is currently a 2-byte identifier contained in the header 110 of the block. Among the other information contained in the header 110 of the block is a file address, which is currently configured as a 4-byte address, and provides chaining to overflow blocks. For example, the file address of the first overflow block is placed in the forward chain field 116 of the prime block. In turn, the file address of the second overflow block is placed into the forward chain field of the first overflow block, and so on.

In addition to the basic file structure discussed above, TPFDF also supports a basic index support mechanism by which an LREC in one file (referred to as the “index file”) points or refers to a subfile of another file (referred to as the “detail file”). This basic index support structure is illustrated in FIG. 3, in which an application program processes customer data. The high-level index file 300 contains individual LRECs 302 of customer names and file addresses of detail subfiles that correspond to that customer in the LREC. Thus, in processing information for a customer named Jones, the TPFDF searches the high-level index file 300 to find the reference to the detail file 304 for Jones. This basic index support is transparent to the application program. Moreover, TPFDF further supports features such as multiple level index files (e.g., a high-level index file pointing to an intermediate index file that in turn points to a detail file), multiple high-level index files pointing to the same detail file, and a single high-level index file pointing to multiple detail files.

A modification of the TPFDF structure was recently proposed in order to allow TPFDF to use file addresses that are 8-bytes in size. While a large (but nonetheless limited) number of file addresses are available using the present 4-byte format, an 8-byte format would exponentially increase the number of file addresses available in the database. In order to convert a TPFDF database to an 8-byte file address format, 4-byte file address references in existing data blocks need to be expanded to be 8-bytes in size. However, the expansion of the data fields in the blocks requires additional data blocks to be used. Furthermore, during such a conversion, data is copied to new physical blocks to allow for fallback to the old blocks. In other words, since 8-byte file address data blocks cannot be used until all references have been converted to 8-byte format, 4-byte file address data blocks must be used. If a user is running out of 4-byte file address blocks (which presumably would be the primary reason for migrating to the new format in the first place), this conversion can be problematic.

Accordingly, it would be desirable to be able to convert the present TPFDF 4-byte address format in a gradual manner so as not to require a continued use of many of the old-style 4-byte file address blocks, which may be in short supply.

### SUMMARY

The above discussed drawbacks and deficiencies of the prior art are overcome or alleviated by a method for implementing staged database migration of a database. In an exemplary embodiment, the method includes implementing a first migration stage by expanding headers for one or more subfiles from a first file address format to a second file address format, wherein subsequent overflow blocks to be associated with said one or more subfiles are selectable from an address space corresponding to said second file address format. A second migration stage is implemented, including expanding file address references of one or more index files from the first file address format to the second address format. The file address references are located within logical records (LRECs) in the one or more index files, the file address references pointing to one or more of the subfiles.

In another embodiment, a method for implementing staged database migration of a Transaction Processing Facility (TPF) database includes implementing a first migration stage by expanding headers for one or more subfiles from a 4-byte address to an 8-byte address, wherein subsequent overflow blocks to be associated with the one or more subfiles are selectable from the first migration stage is determined to produce insufficient address relief. The second migration stage includes expanding file address references of one or more index files from 4-bytes to 8-bytes, wherein the file address references are located within logical records (LRECs) in the one or more index files, the file address references pointing to one or more of the subfiles.

In another embodiment, a storage medium includes a machine readable computer program code for implementing staged database migration of a Transaction Processing Facility (TPF) database, and instructions for causing a computer to implement a method. The method further includes implementing a first migration stage by expanding headers for one or more subfiles from a 4-byte address to an 8-byte address, wherein subsequent overflow blocks to be associated with the one or more subfiles are selectable from the first migration stage is determined to produce insufficient address relief. The second migration stage includes expanding file address references of one or more index files from 4-bytes to 8-bytes, wherein the file address references are located within logical records (LRECs) in the one or more index files, the file address references pointing to one or more of the subfiles.

### BRIEF DESCRIPTION OF THE DRAWINGS

Referring to the exemplary drawings wherein like elements are numbered alike in the several Figures:

FIGS. 1 and 2 are schematic diagrams of the logical structure of an exemplary TPFDF file as presently formatted;

FIG. 3 is a schematic diagram of the basic index support structure provided by TPFDF; and

FIG. 4 is a flow diagram illustrating a method for migrating a TPFDF 4-byte address format, in accordance with an embodiment of the invention.

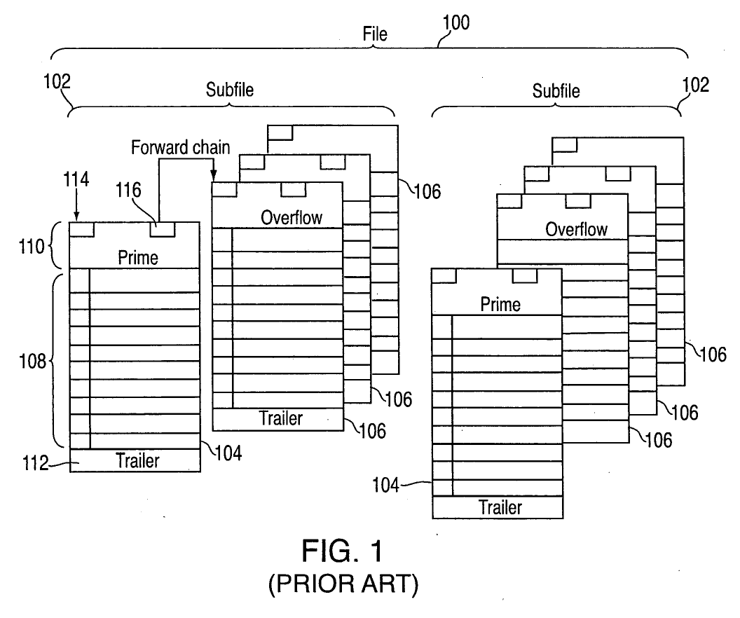

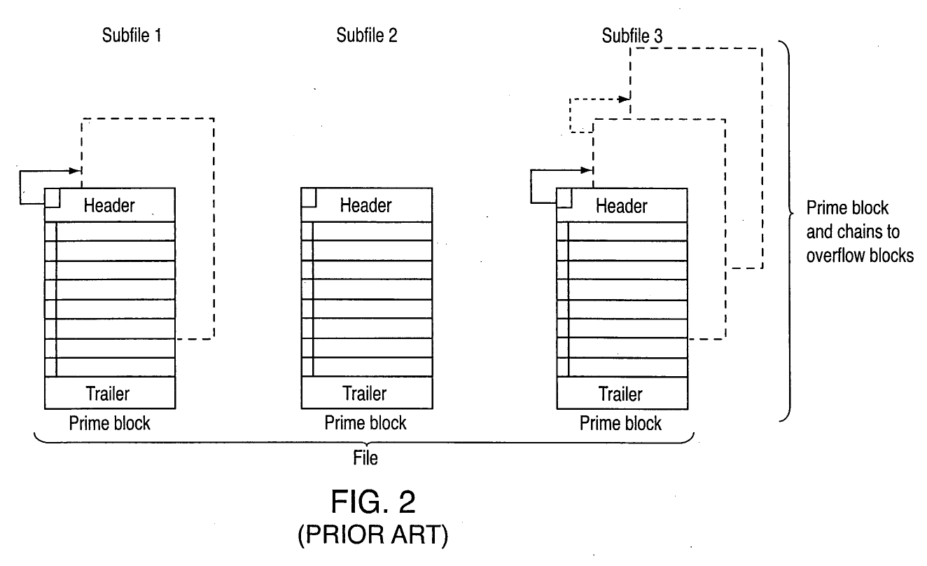

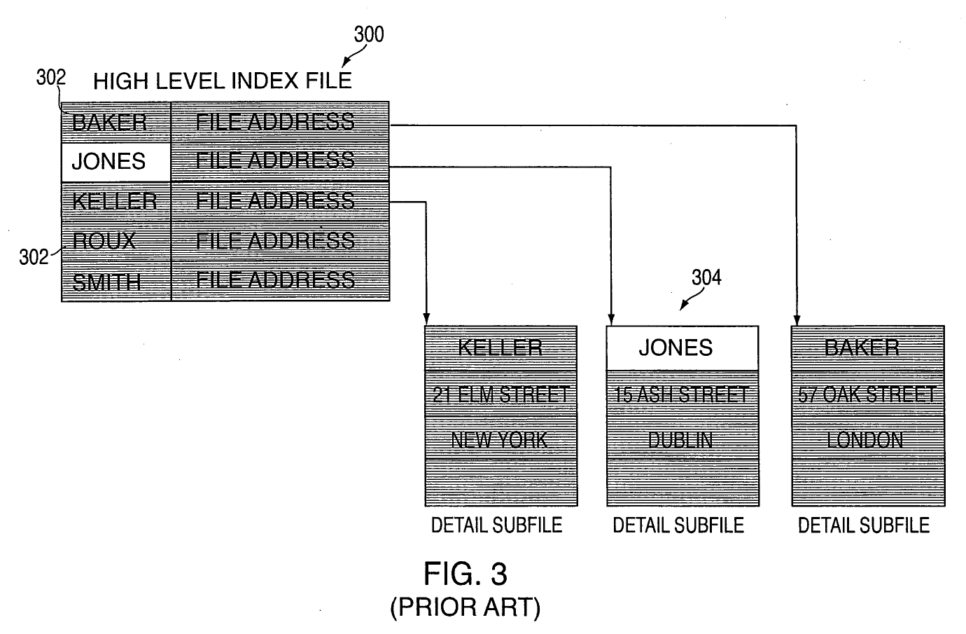

### DETAILED DESCRIPTION

Disclosed herein is a method for database migration using a staged approach to provide incremental functionality on an as-available basis. In particular, the migration method provides database migration to a new format (a different file addressing scheme in the exemplary embodiments) while the database is continuously available. This is implemented through a staged approach to the database migration wherein the database is continuously available, and without the need for duplication of data. With more traditional approaches, the database is not available for at least part of (or even the entire duration of) the migration. Thus, the methodology disclosed herein is particularly suited for customers who require “24/7” database availability. As will be appreciated, the migration method may be applied to any database migration requiring extensive changes to the format of an existing database.

In the embodiments described hereinafter, several options exist for introducing 8-byte file address blocks into the databases. First, the 8-byte file address format may be applied to overflow blocks only, or additional migration activities (e.g., data conversion and application updates) can be performed so as to apply the 8-byte address format to both prime and overflow blocks in a subfile. Furthermore, 8-byte file address blocks can be introduced as new blocks are needed, or the data in existing blocks can be copied to new blocks that use 8-byte file addresses, with the system automatically updating all internal references.

In addition, in order to reduce the application time-to-market when migrating to the new database, new application programming interfaces (APIs) that are required to be used with the new file address formats can be made available for applications to use before migration is completed or even started. These APIs would be fully compatible with both 4-byte and 8-byte file address blocks. By providing this compatibility, application cut-overs can be done either in advance of or during migration activities to prepare for the introduction of 8-byte file address blocks into a database.

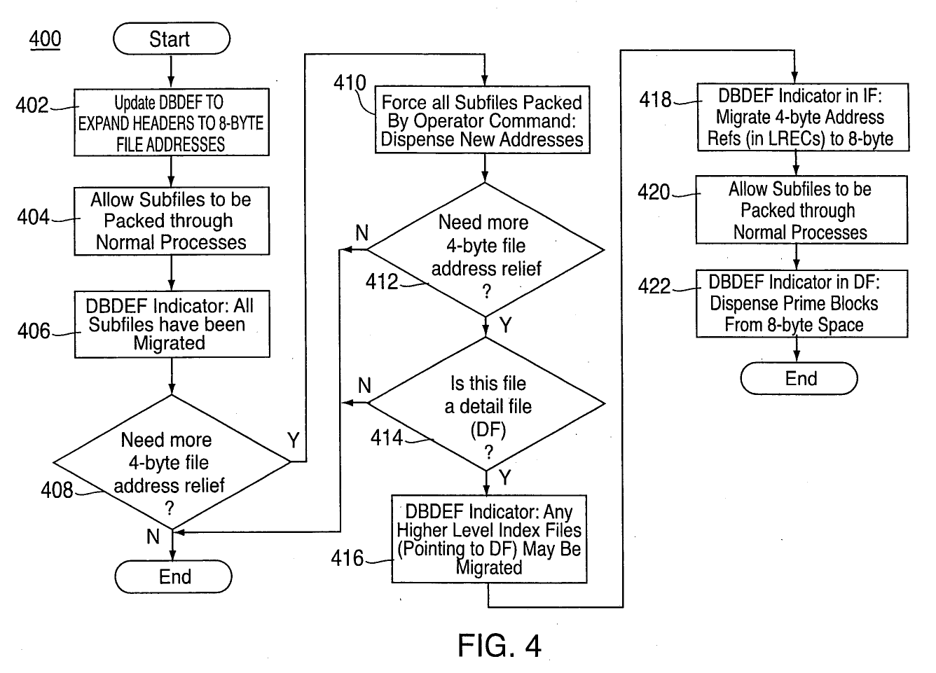

Referring now to FIG. 4, there is shown a flow diagram 400 illustrating a method for migrating a TPFDF 4-byte address format, in accordance with an embodiment of the invention. As is shown, users who need to migrate an existing database to use the new file address format can perform the migration in stages. Generally, migration involves expanding block headers and any internal file address references to support 8-byte file addresses references (even if the block itself is still a 4-byte file address). Instead of migrating an entire file at one time, users have the flexibility to select either one subfile or a range of subfiles to be processed at a time. Once these migrations have been confirmed, a disk utility can be used to recover the 4-byte file address blocks that are no longer needed, and make them available to subsequent migrations. This way, minimal additional usage of the 4-byte file address blocks is required.

In the particular example of FIG. 4, the migration method 400 begins as shown in block 402, wherein a database definition (DBDEF) is updated to indicate that forward chain fields in the header should now be expanded from 4-byte file addresses to 8-byte addresses. In a TPFDF product, DBDEF tables contain detailed information about each file in the database. For example, DBDEF tables hold information about the location, organization and processing attributes of the database, as well as information about the characteristics of a file. Application programs directly or indirectly use DBDEF tables, which are generated using a DBDEF macro instruction with parameters that describe the file to the TPFDF product.

Upon updating of the DBDEF with the new expanded header definition, subfiles are then allowed to be packed as shown in block 404, by normal database processes for example, or by a specific operator command. As a result of the packing operations, the headers of the packed subfiles are now expanded to have 8-byte file addresses. Then, as shown in block 406, the appropriate DBDEF indicator is set to indicate that the packed subfiles have been migrated to expanded headers having 8-byte file addresses. Thereafter, any new overflow pool records for the database may be obtained from the 8-byte address space. In TPFDF parlance, pool files consist of pool blocks that are used as prime blocks and overflow blocks in a file.

In the exemplary embodiment depicted, the migration is a staged approach. Thus, it is determined at decision block 408 whether additional 4-byte address file relief is needed (i.e., the first stage provides insufficient relief). To this point, 4-byte file address block headers have been expanded to 8-byte file address headers within prime and overflow blocks. Once this migration stage is completed, 8-byte file address blocks can be dispensed for overflow chains without any additional migration being needed, including any application updates. This is due to the fact that in hierarchical database layouts, only the prime subfile blocks are referenced from a higher level index structure, so there would not be a need to expand any index references if the file address of the prime block remains 4-bytes in size. Depending on the particular database layouts, this may provide users sufficient relief from any shortage of 4-byte file addresses to eliminate the need for further or more costly migrations. Thus, if no further relief is needed, the migration process can end at this point.

On the other hand, if additional file address relief is needed, method 400 proceeds to a further stage at block 410, where all subfiles in the database are forced to be packed by operator command, with the specification that new file addresses are to be dispensed. This process converts all 4-byte overflow records to 8-byte file addresses. As shown in decision block 412, it is again determined whether further 4-byte file address relief is needed. If not, the migration process can terminate at this stage. Otherwise, the method proceeds to decision block 414 to see whether the file is a detail file. It will be recalled from above that a detail file is one that is referred or pointed to by a higher level index file. If the file is not a detail file, then no additional migration relief is available at this point, and the migration process ends for that file. The process may be repeated as needed for other files in the database.

However, assuming that the database file is a detail file, then the migration process proceeds to block 416, wherein the DBDEF indicator is set to indicate that any higher level index files pointing to the detail file may be expanded to 8-byte references. Then, as shown at block 418, the DBDEF indicator for the higher level index file(s) are set to indicate that the 4-byte file address references located within the individual LRECs are to be migrated to 8-byte format. The subfiles referenced by the higher level index files are then packed through normal processes or through an operator command, as shown in block 420. This packing results in the expansion of the address references within the LRECs of the index files to the 8-byte format.

Finally, in block 422, an additional DBDEF indicator in the detail file is set to indicate that all index reference migrations have been completed, such that prime blocks may now be dispensed from the 8-byte file address space. Where the system runs with a warning mode enabled, an error will be generated if a 4-byte index reference to a subfile is encountered whose database definition indicates that prime blocks are to use 8-byte file address formats.

In view of the above, the present method embodiments may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above and illustrated in FIG. 4.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for implementing staged database migration of a database, the method comprising:
implementing a first migration stage by expanding headers for one or more subfiles from a first file address format to a second file address format, wherein subsequent overflow blocks to be associated with said one or more subfiles are selectable from an address space corresponding to said second file address format; and
implementing a second migration stage, said second migration stage comprising expanding file address references of one or more index files from said first file address format to said second address format;
wherein said file address references are located within logical records (LRECs) in said one or more index files, said file address references pointing to one or more of said subfiles.

2. The method of claim 1, wherein said second migration stage is implemented in the event said first migration stage is determined to provide insufficient storage relief.

3. The method of claim 1, wherein said first migration stage further comprises:
updating a first database definition (DBDEF) indicator to indicate subfile address headers are expanded from said first address format to said second file address format; and
expanding said headers for said one or more subfiles during database packing operations.

4. The method of claim 3, wherein said one or more subfiles are packed by operator command.

5. The method of claim 3, further comprising:
updating a second DBDEF indicator to indicate the completion of migration of said one or more subfiles to said second file address format; and
indicating that new overflow blocks are obtainable from the address space of said second file address format.

6. The method of claim 5, wherein said second migration stage further comprises:
updating a third DBDEF indicator to indicate said file address references are expanded from said first address format to said second file address format; and
expanding said file address references for said one or more index files during database packing operations.

7. The method of claim 6, wherein said one or more index files are packed by operator command.

8. The method of claim 6, further comprising:
updating a fourth DBDEF indicator to indicate the completion of migration of said one or more index to said second file address format; and
indicating that new prime blocks are obtainable from the address space of said second file address format.

9. The method of claim 1, wherein said first file address format comprises a 4-bit file address and said second file address format comprises an 8-bit file address.

10. The method of claim 1, further comprising forcing each subfile in the database to be packed by operator command so as to result in said address headers for each subfile to be expanded from said first address format to said second file address format, thereby causing each subsequent overflow block to be obtained from the address space of said second file address format.

11. A method for implementing staged database migration of a Transaction Processing Facility (TPF) database, the method comprising:
implementing a first migration stage by expanding headers for one or more subfiles from a 4-byte address to an 8-byte address, wherein subsequent overflow blocks to be associated with said one or more subfiles are selectable from an 8-byte address space; and
implementing a second migration stage in the event said first migration stage is determined to produce insufficient address relief, said second migration stage comprising expanding file address references of one or more index files from 4-bytes to 8-bytes;
wherein said file address references are located within logical records (LRECs) in said one or more index files, said file address references pointing to one or more of said subfiles.

12. The method of claim 11, wherein said first migration stage further comprises:
updating a first database definition (DBDEF) indicator to indicate subfile address headers are expanded from 4-bytes to 8-bytes;
expanding said headers for said one or more subfiles during database packing operations;
updating a second DBDEF indicator to indicate the completion of migration of said subfile address headers to 8-bytes; and
indicating that new overflow blocks are obtainable from an 8-byte address space.

13. The method of claim 12, wherein said one or more subfiles are packed by operator command.

14. The method of claim 12, wherein said second migration stage further comprises:
updating a third DBDEF indicator to indicate said file address references are expanded from 4-bytes to 8-bytes;
expanding said file address references for said one or more index files during database packing operations;
updating a fourth DBDEF indicator to indicate the completion of migration of said one or more index to 8-bytes; and
indicating that new prime blocks are obtainable from said 8-byte address space.

15. The method of claim 14, wherein said one or more index files are packed by operator command.

16. A storage medium, comprising:
a machine readable computer program code for implementing staged database migration of a Transaction Processing Facility (TPF) database; and
instructions for causing a computer to implement a method, the method further comprising:
implementing a first migration stage by expanding headers for one or more subfiles from a 4-byte address to an 8-byte address, wherein subsequent overflow blocks to be associated with said one or more subfiles are selectable from an 8-byte address space; and
implementing a second migration stage in the event said first migration stage is determined to produce insufficient address relief, said second migration stage comprising expanding file address references of one or more index files from 4-bytes to 8-bytes;
wherein said file address references are located within logical records (LRECs) in said one or more index files, said file address references pointing to one or more of said subfiles.

17. The storage medium of claim 16, wherein said first migration stage further comprises:
updating a first database definition (DBDEF) indicator to indicate subfile address headers are expanded from 4-bytes to 8-bytes;
expanding said headers for said one or more subfiles during database packing operations;
updating a second DBDEF indicator to indicate the completion of migration of said subfile address headers to 8-bytes; and
indicating that new overflow blocks are obtainable from an 8-byte address space.

18. The storage medium of claim 17, wherein said one or more subfiles are packed by operator command.

19. The storage medium of claim 17, wherein said second migration stage further comprises:
updating a third DBDEF indicator to indicate said file address references are expanded from 4-bytes to 8-bytes;
expanding said file address references for said one or more index files during database packing operations;
updating a fourth DBDEF indicator to indicate the completion of migration of said one or more index to 8-bytes; and
indicating that new prime blocks are obtainable from said 8-byte address space.

20. The storage medium of claim 19, wherein said one or more index files are packed by operator command.
